(19) United States
(12) Patent Application Publication
(10) Pub. No.: US 2018/0300787 A1
(43) Pub. Date: Oct. 18, 2018

(54) SYSTEM AND METHOD FOR SYNCHRONOUS PEER-TO-PEER COMMUNICATION BASED ON RELEVANCE

(71) Applicant: Engage, Inc., Seattle, WA (US)

(72) Inventors: Danny Patterson, Shorewood, MN (US); Lief Larson, Seattle, WA (US)

(21) Appl. No.: 15/490,376

(22) Filed: Apr. 18, 2017

(51) Int. Cl. G06Q 30/06; H04L 29/08; H04L 12/58; G06F 17/30; G06Q 30/02; G06Q 50/14

(52) U.S. Cl. CPC G06Q 30/0625; H04L 67/104; H04L 67/30; G06Q 50/14; G06F 17/30864; G06Q 30/0277; H04L 51/046

(57) ABSTRACT

A system for establishing peer-to-peer communication options based on web search relevance, comprising: a presence cache configured to store a plurality of agent profiles, wherein each of the plurality of agent profiles includes a communication socket and one or more metadata. A rules engine is configured to apply a plurality of rules to the one or more metadata associated with the plurality of agent profiles, the plurality of rules along with the metadata are pushed to the presence cache in real-time. A search module communicatively coupled to the presence cache and operable to receive at least one web search request from a user and retrieve available ones of the at least one of the plurality of agent profiles relevant to the at least one web search request based on the plurality of rules from the rules engine.

### TECHNICAL FIELD

This disclosure generally relates to synchronous peer-to-peer communication based on web search relevance, and more specifically to system and methods for providing synchronously available chat agents syndicated to locations throughout the World. Wide Web.

### BACKGROUND OF THE DISCLOSURE

Self-service e-commerce websites for commoditized goods and services is ubiquitous. Existing e-commerce sites allow consumers to select a product for delivery with little to no direct human contact. Currently, there is no easy way for web-based consumers to approach humans or even Artificial Intelligence (AI) chat hots in an anonymous state and conduct synchronous communication (e.g., messaging).

Using legacy “live chat” buttons on company websites, consumers are required to disclose Personally Identifiable Information (PII) and have no choice with whom they communicate with. The legacy “live chat” systems merely route consumers to a chat session queue to eventually become connected with a representative who has been selected based on a call center queue. As such, preservation of consumer anonymity and having the ability to specifically select with whom consumers communicate with are absent from legacy web systems.

It is desirable to establish a system and method for allowing sales agents or representatives to indicate when they're available for synchronous communication with consumers, as well as having the sales agents' unique identity readily viewable to web consumers.

### BRIEF DESCRIPTION OF THE DRAWINGS

Reference will now made to the attached drawings, when read in combination with the following specification, wherein like reference numerals refer to like parts throughout the several views, and in which:

FIG. 1 is a schematic illustration of a synchronous peer-to-peer (P2P) communication system, according to one illustrated embodiment.

FIG. 2. is an illustration of a search engine results page (SERP), according to a current state of the art, in response to a “Caribbean cruise” search, according to one illustrated embodiment.

FIG. 3 is an illustration of a search engine results page (SERP) displaying a plurality of agent profiles above search results, according to one illustrated embodiment.

FIG. 4 is an illustration of a SERP where a user initiated a synchronous P2P communication session with an agent, according to one illustrated embodiment.

FIG. 5 is an illustration of a graphical user interface of a dashboard module used by the agent to control the P2P communication, according to one illustrated embodiment.

FIG. 6A is an illustration of an agent profile landing page accessed via an agent-specific URL (uniform resource locator) when the agent is available for synchronous communication, according to one illustrated embodiment.

FIG. 6B is an illustration of the agent profile landing page accessed via the agent-specific URL (uniform resource locator) when the agent is available for asynchronous communication.

FIG. 7 is an illustration of a user having a synchronous P2P communication with the agent via the agent-specific URL, according to one illustrated embodiment.

FIG. 8 is an illustration of the agent-specific URL when the P2P communication has concluded, according to one illustrated embodiment.

FIG. 9 is an illustration of an organization directory interface, including a plurality of agent profiles associated with the organization, according to one illustrated embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various examples of embodiments of the invention will now be described. The following description provides specific details for a thorough understanding and enabling description of these examples. One skilled in the relevant art will understand, however, that embodiments of the invention may be practiced without many of these details. Likewise, one skilled in the relevant art will also understand that embodiments incorporate many other obvious features not described in detail herein. Additionally, some well-known structures or functions may not be shown or described in detail below, so as to avoid unnecessarily obscuring the relevant description.

The terminology used herein is to be interpreted in its broadest reasonable manner, even though it is being used in conjunction with a detailed description of certain specific examples of the invention. Indeed, certain terms may even be emphasized below; any terminology intended to be interpreted in any restricted manner will, however, be overtly and specifically defined as such in this Detailed Description section.

The figures along with the following discussion provide a brief, general description of a suitable environment in which embodiments of the invention can be implemented. Although not required, aspects of various embodiments are described below in the general context of computer-executable instructions, such as routines executed by a general purpose data processing module, e.g., a networked server computer, cloud server, mobile device, tablet, or personal computer. Those skilled in the relevant art will appreciate that embodiments can be practiced with other communications, data processing, or computer system configurations, including: Internet appliances, hand-held devices (including smart phones, tablets, and personal digital assistants (PDAs)), wearable computers, all manner of corded, landline, fixed line, cordless, cellular or mobile phones, smart phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While embodiments of the invention, such as certain functions, may be described as being performed on a single device, embodiments of the invention can also be practiced in distributed environments where functions or modules are shared among disparate processing devices, which are linked through a communications network, such as, for example, a Local Area. Network (LAN), Wide Area Network (WAN), the Internet, Bluetooth, and Zigbee. In a distributed computing environment, program modules may be located in both local and remote memory storage devices.

Embodiments of the invention may be stored or distributed on tangible computer-readable media, including magnetically or optically readable computer discs, cloud servers, hard-wired or preprogrammed chips (e.g., EEPROM semiconductor chips), nanotechnology memory, biological memory, or other data storage media. Alternatively or additionally, computer implemented instructions, data structures, screen displays, and other data under aspects of embodiments of the invention may be distributed over the Internet and via cloud computing networks or on any analog or digital network (packet switched, circuit switched, or other scheme).

The computer readable medium stores computer data, which data may include computer program code that is executable by a computer, in machine readable form. By way of example, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Embodiments of the invention are described herein with reference to operational illustration of modules having functional blocks to illustrate methods employed by modules to establish peer-to-peer (P2P) communication options based on web search relevance. It will be understood that each of the modules, blocks, and combinations thereof may be implemented by analog or digital hardware and computer program instructions. The computer program instructions may be provided to a processor of a general purpose computer, special purpose computer, application-specific integrated circuit (ASIC), or other programmable data processing apparatus such that the instructions, which execute via the processor of the computer or other programmable data processing apparatus, implements the functions/acts specified in the functional blocks of the flowcharts and/or the operational modules.

In some embodiments, the methods illustrated by the functional blocks may occur out of the order noted in the operational illustration of the modules. For example, two blocks shown in succession may be executed substantially concurrently. Alternatively and/or additionally, the blocks may be executed in reverse order.

A module is a software, hardware, or firmware (or combination thereof) system, process or functionality, or component thereof, that performs or facilitates the processes, features, and/or functions described herein. A module may include sub-modules. Software components of a module may be stored on a computer readable medium. Modules may be integral to one or more servers, or be loaded and executed by one or more servers. One or more modules may be grouped into an application.

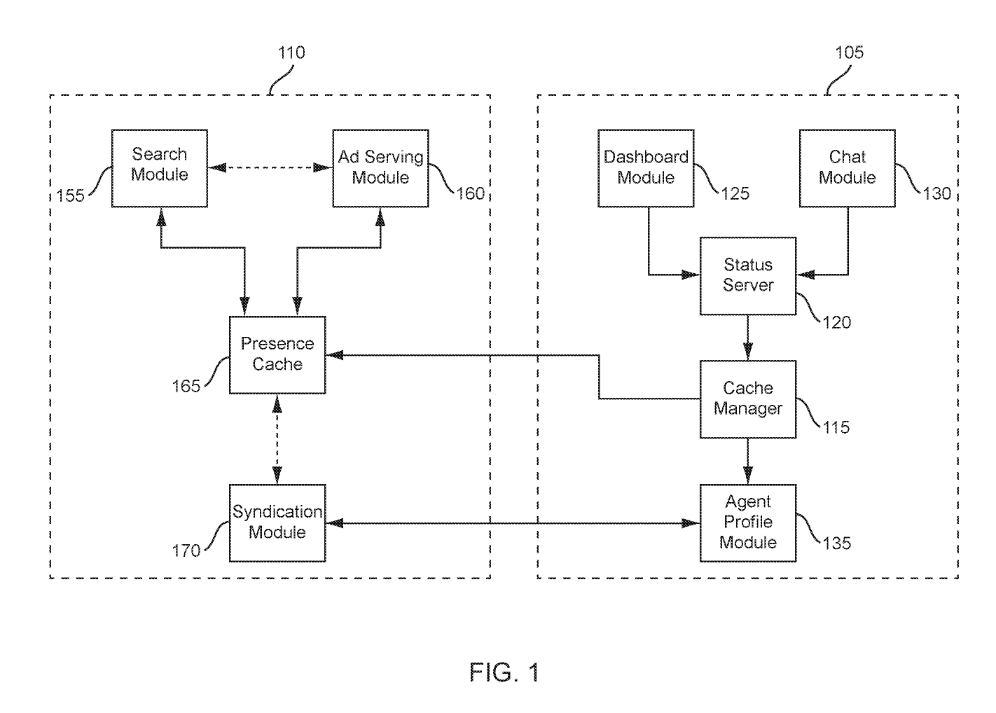

FIG. 1 shows a schematic illustration of a synchronous peer-to-peer (P2P) communication system 100, according to one embodiment.

The system 100 comprises a back-end subsystem 105 communicatively coupled to a web-based subsystem 110. As will be described in more detail herein, the back-end subsystem 105 is operable to maintain and update metadata associated with a plurality of agent profiles 140, as well as rules to be applied to the metadata. The rules applied to the real-time updated metadata is used by the web-based subsystem 110 to display a listing of agent profiles available for synchronous and asynchronous communication that are relevant to a user of the web-based subsystem 110.

In particular, the back-end subsystem 105 comprises a cache manager 115, a status server 120, a dashboard module 125, a chat server 130, and an agent profile module 135. The cache manager 115 may be configured to store a plurality of agent profiles 140 and associated plurality of metadata 145. The cache manager 115 may further include a rules engine to apply a plurality of rules to the plurality of agent profiles 140 and associated plurality of metadata 145. The plurality of agent profiles 140 may comprise structured data, including at least one of rich interactive advertisement, rich media, text-based data object, or a widget. The plurality of agent profiles 140 represent communication agents, sales agents, or representatives (hereinafter referred to as “agents”) capable of engaging in a real-time communication with a consumer via a web portal. One example of agents or representatives may include travel agents, real estate agents, or consumer product sales agents to name a few. It will be understood by those of ordinary skill in the art that agents or representative may be a sales agent or representative associated with any other industry. The agents may be humans, Artificial Intelligence (AI) bots, or a combination thereof that may conduct synchronous or asynchronous communication with a consumer searching for goods or services where the agents have expertise or insights. Although reference throughout the application may be to synchronous communication, it will be understood that asynchronous communication is also contemplated by embodiments described herein.

As mentioned above, the plurality of agent profiles 140 may take the form of structured data. As is known in the art, structured data may refer to types of data with a high level of organization, such as information in a relational database. When information is highly structured and predictable, search engines can more easily organize and display such information in creative ways. Structured data markup is a text-based organization of data that is included in a file and served from the web. It typically uses the schema.org vocabulary—an open community effort to promote standard structured data in a variety of online applications.

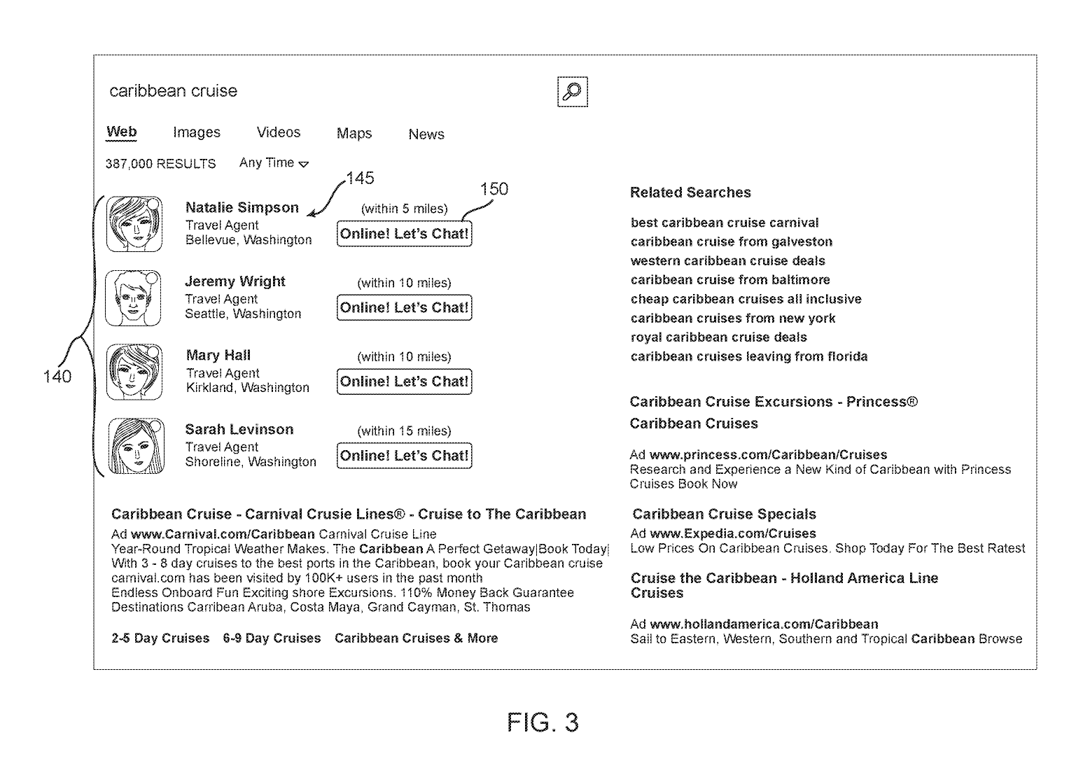

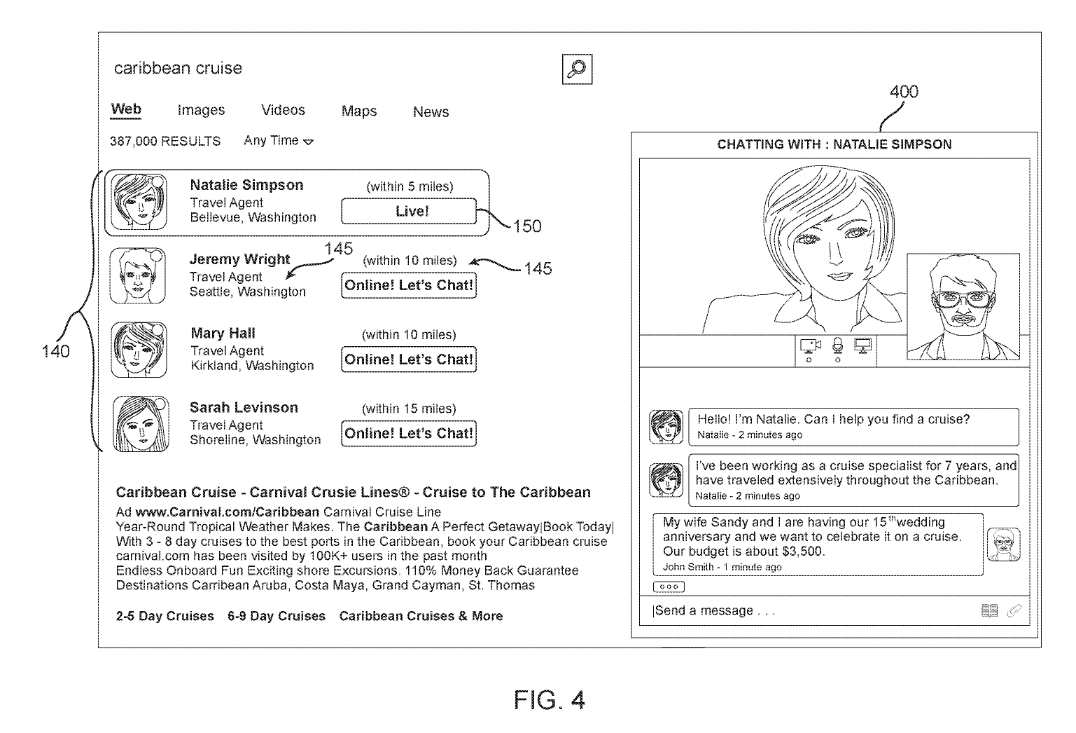

Structured data markup may for example be represented in JSON-LD (JavaScript Object Notation for Linked Data) format. JavaScript notation may be separate from a body of the HTML itself. Markup is placed inside a script tag in the head of the HTML page. The markup does not have to be interleaved with the user-visible structured data. The markup describes things on the web, along with their properties. For example, if a website has recipes, markup could be used to describe properties for each recipe, such as the summary, a uniform resource locator (URL) to a photo for the dish, and its overall rating from users. In another example described herein, the structured data of respective ones of the agent profiles 140 uses the plurality of metadata 145 to describe information associated with the agents, the agents' organizations, or a combination thereof. In one example, as illustrated in FIGS. 3-4, the metadata 145 includes communication availability status of the agent, geographic location of the agent, agent profile image, skills, job title, subject matter expertise, and organization affiliation to name a few. It will be understood by those of ordinary skill in the art that various other types of metadata can be included, such as ratings of agent, size of agent's organization, consumer's prior history with the agent, pay-per-dialogue rate agent willing to spend, agent's historical time-to-response rate, years of agent's job experience, etc.

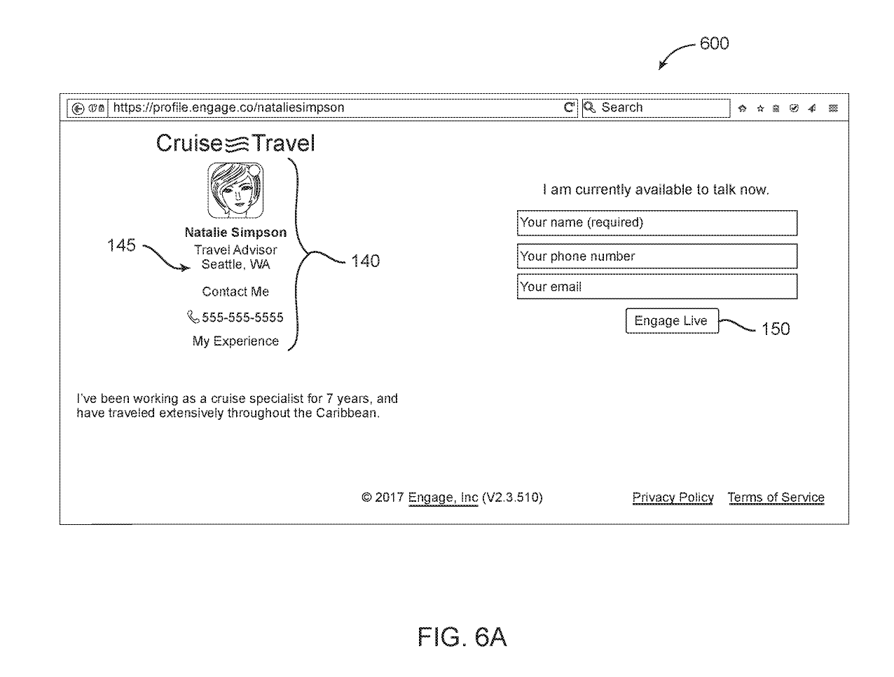

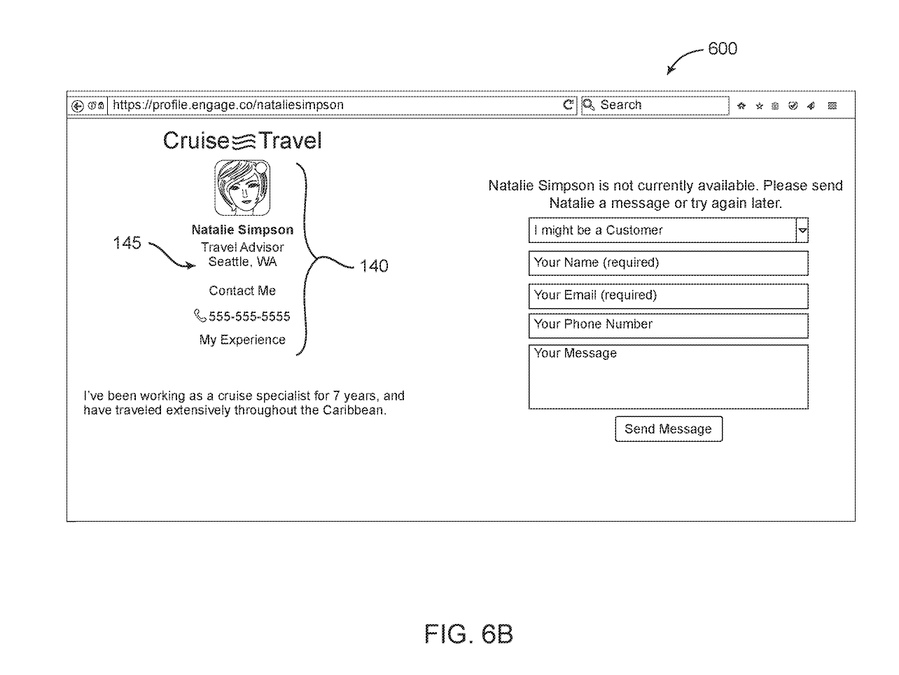

Embedded within the structured data of each of the plurality of profiles 140 may include a communication socket 150 along with the plurality of associated metadata 145. The communication socket 150 may be an endpoint of a two-way communication link between the consumer and the agent. For example, the chat server 130 may detect a communication request from the consumer via the communication socket 150. The communication request may be initiated by a consumer selecting a communication icon associated with the communication socket 150. In one example, the communication icon may take the form of a “Let's Chat” icon or the like. The established communication link may take the form of a synchronous voice over internet protocol (VoIP), video over internet protocol, or text-based communication. In some embodiments, in response to establishing the communication link, a communication web portal 400 (See, FIG. 4) is opened between the user and the agent. The communication web portal 400 may be accessible via any web browser known in the art without installing additional software add-ons, web-browser plug-ins or extensions, or the like. As such, the users may communicate natively from their respective browsers. Additionally, as illustrated in FIGS. 6A-6B, 7, and 8, the communication portal 400 may have a unique URL (e.g., https://profile.engage.co/nataliesimpson) associated therewith to allow the user to re-establish a communication session with the same agent in the future.

The status server 130 is configured to update the communication availability of the agents associated with respective ones of the plurality of agent profiles 140. Based on the communication availability status associated with respective ones of the plurality of agent profiles 140, the communication socket 150 may be available or unavailable to transmit a communication request and establish a real-time communication session. The status server 130 may update the communication availability status of the communication socket 150 in real-time. In one embodiment, the status server 130 is operable to update the availability status to “UNAVAILABLE” for respective ones of the plurality of agent profiles in response to the respective ones of the agents conducting a defined number of concurrent communication sessions with different users. For example, if the agent may be capable of conducting a simultaneous chat session with up to three users, the agent's associated availability status may be “AVAILABLE” till three users are simultaneously communicating with the agent. Once three concurrent communication sessions are established, the status server 120 may update the agent's availability status to “UNAVAILABLE” or “BUSY,” for example.

As mentioned above, the plurality of metadata 145 may include availability status configured to indicate whether the agent associated with the respective agent profile 140 is currently available to communicate via the communication socket 150. In some embodiments, the availability status may provide granularity as to specific communication availability status. For example, the availability status may specifically indicate whether the agent is available for text, audio, VoIP, or video messaging (e.g., AVAILABLE FOR CHAT ONLY, AVAILABLE VIA AUDIO ONLY, AVAILABLE VIA VIDEO AND AUDIO, etc.). Alternatively and/or additionally, the indicator may display a message indicating unavailable but will be available soon (e.g., “AWAY,” “BUSY,” or “BE BACK IN 5 MIN”), It will be appreciated by those of ordinary skill in the art that any combination of availability messaging is well within the scope of embodiments described herein.

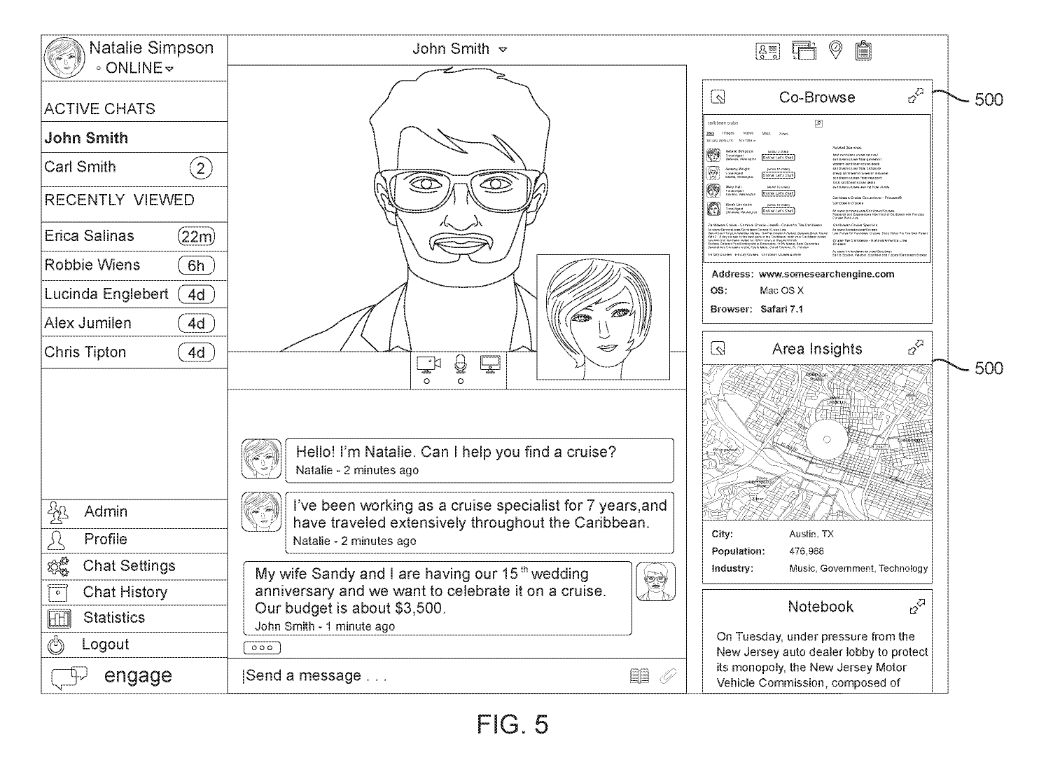

The dashboard module 125 may serve as a control interface to the plurality of agent profiles 140. In other words, the respective agents associated with the plurality of agent profiles 140 may log into the dashboard module 125 and update various ones of the plurality of metadata 145. For example, the agent may manually update his/her communication availability status via the dashboard module 125 or update availability criteria for automatic status changes based on usage. In particular, the dashboard module 125 provides the agent with the ability to define the number of concurrent communication sessions the agent is able to handle before automatically setting the communication availability status to UNAVAILABLE. Additionally, as will be discussed in detail herein with regard to FIG. 5, the dashboard module 120 may be configured to govern the agent's real-time conversation with the user. In particular, the dashboard module 125 allows the agent to toggle between concurrent communication sessions with different users and view a representation of the users' web actions in real-time.

The chat server module 130 may be communicatively coupled to the status server 120 and the communications socket 150 of respective ones of the plurality of profile agents 140. The chat server module 130 may take the form of a cluster of chat servers configured to integrate with the synchronous peer-to-peer (P2P) communication system 100. In response to the agent associated with the agent profile 140 authenticating within the P2P communication system 100 by way of logging in to the dashboard for example, the agent is assigned to one of the chat servers of the chat server module 130. In particular, the chat server module 130 may include a chat dialogue relay to assign the respective agents to the appropriate chat server. The assignment of the agent to at least one of the chat servers of the chat server module 130 is based on load balancing and availability checks.

The agent profile module 135 is communicatively coupled to the cache manager 115. The agent profile module 135 comprises structured data pertaining to the agent's profile page (See, 600 at FIGS. 6A-6B). The agent profile module 135 includes the plurality of agent profiles 140 in the form of structured data to be deployed as advertisements or widgets across the web, where the advertisements or widgets include at least one of the plurality of metadata 145 associated with the agent's profile page 600. In other words, the plurality of agent profiles 140 (in the form of widgets or advertisements) serve as an interface to connect to the respective agent profile pages. The agent profile module 135 may update the availability of the agents associated with the plurality of agent profiles 140 by way of being communicatively coupled to the cache manager 115.

It should be noted, the unique URL associated with the communication portal provides access to the agent's profile page (FIGS. 6A-6B). It is from the agent's profile page that the user may initiate a synchronous or asynchronous communication with the agent. In one embodiment, the agent's profile page allows for the dynamic switching between synchronous and asynchronous communication, as will be described in more detail herein.

The web-based subsystem 110 comprises a search module 155 communicative coupled to an ad serving module 160. Both the search module 155 and the ad serving module 160 are communicatively coupled to a presence cache 165. The web-based subsystem 110 further comprising a syndication module 170,

The search module 155 comprises a search algorithm that may accept a web search request, for example in the form of Boolean string keywords, and then determines web search results. The search module 155 may, for example, index websites across the World Wide Web (“Web”). In response to a web search request by the user, the search module 155 may search the indexed websites to identify relevant websites to be linked to a listing of web search results, also known as a Search Engine Results Page (SERP). Additionally, the search module 155 may be configured to access the presence cache 165 to associate at least one of the plurality of agent profiles 140 with the SERP. The search module 155 may, for example, display the plurality of agent profiles 140 proximate the listing of web search results on the SERP, as illustrated in FIGS. 3-4.

In one embodiment, the search module 155 organically determines the plurality of agent profiles 140 that are relevant to display on the SERP based on contextual relevance of the web search request. In other words, the search module 155 may identify and display those ones of the plurality of agent profiles 140 having metadata 145 contextually relevant to the results page. For example, a search for “Caribbean cruise” may identify and display travel agent profiles that specialize in Caribbean cruises, while a search for “Thailand travel” may identify and display respective ones of the agent profiles 140 having agents who specialize in traveling to and within Thailand.

The ad serving module 160 communicatively coupled to the presence cache 165 determines the plurality of agent profiles 140 relevant to display as advertisements on the SERP in response to the plurality of rules pushed from the cache manager 115 to the presence cache 165. The plurality of rules associated with respective ones of the plurality of agent profiles 140 may include specific advertising criteria (e.g., IP geolocation, keywords). The advertising criteria or variables may be purchased by the agents and/or the organizations such that specified ones of the plurality of agent profiles 140 will be displayed on a SERP even if not contextually relevant via organic search methods. For example, an agent located in Florida might be interested to have his/her associated agent profile 140 appear on a SERP when any user located in Seattle submits any web search request regardless of subject matter content.

In particular, the presence cache 165 receives the rules from the cache manager 115, including any real-time updates to the plurality of metadata 145. For example, availability indicators and/or advertising criteria may be automatically updated and continuously pushed to the presence cache 165 for quick access by the ad serving module 160 and/or the search module 155. It should be noted the plurality of rules may be created by respective managers of the plurality of agents 140. The managers include at least one of agents represented by the plurality of agent profiles 140 or organizations the agents are affiliated with.

As mentioned above, the ad serving module 160 communicatively coupled to the search module 155 and the presence cache 165 is operable to determine the plurality of agent profiles 140 relevant to display as advertisements on the SERP. In one embodiment, in response to the rules, the ad serving module 16( )may associate purchased keywords with respective ones of the plurality of agent profiles 140. The associated purchased keywords may be in the form of respective ones of the plurality of metadata 145. The agent or organization affiliated with respective ones of the plurality of agent profiles 140 may purchase specific key words that would trigger the ad server module 160 to deploy the respective agent profile 140 for display on the SERP via the search module 155.

In another embodiment, the ad serving module 160 may associate a geographic location with respective ones of the plurality of agent profiles 140. The associated geographic locations may be in the form of respective ones of the plurality of metadata 145. The search module 155 may identify the IP geolocation from where the user enters the web search request. The IP geolocation of the user may be identified via the IP address associated with the user's access point. The ad server module 160 may identify those ones of the plurality of agent profiles 140 having metadata 145 of a geographic region that includes the user's IP geolocation. In response, the search module 155 displays the identified ones of the plurality of agent profiles 140 on the SERP.

Upon identifying ones of the plurality of agent profiles 140 to be displayed on the SERP or any other webpage, the agent profiles 140 may be stack-ranked. The plurality of rules (mentioned above) may include stack ranking rules. The stack ranking rules may determine the ordered positioning of the agent profiles being displayed, whether displayed organically via context-based relevance or displayed as advertisements on webpages (e.g., SERP). The agent profiles 140 may be stack-ranked and served up on a SERP, for example, based on a set of variables defined by the stack ranking rules. For example, stack ranking rules may determine stack-ranked priority based at least on one or more of the following variables:
Whether the agent profile 140 indicates the agent is AVAILABLE for real-time synchronous communication.
Whether the agent profile 140 indicates the agent is located in a geographically relevant location to the user.
Whether the agent is contextually relevant to the search request (e.g., user searches for “Caribbean cruises” and agents specializing in booking Caribbean cruises are prioritized in the stack-ranking).
Ratings of the agent from users, size of organization the agent works for or is affiliated with, the cost-per-dialogue rate the agent or organization will pay to be displayed on SERP or webpage, years of job experience, and agent's historical time-to-respond to real-time communication, to name a few.

Furthermore, the stack-ranking rules may take into account another variable, namely a fairness doctrine. The fairness doctrine may be a sub-set of rules dictated by the organizations with whom respective ones of the plurality of agents are affiliated with. For example, for a set of agents within an organization, the organization may establish the fairness doctrine rule that agents who have gone the longest without receiving a communication request (e.g., chat, audio, video, VoIP), will be prioritized in the stack-ranking displayed results. Of course, the organization may update its fairness doctrine in real-time via the dashboard, for example. The updated fairness doctrine rules may be pushed from the cache manager 115 to the presence cache 165.

It will be appreciated by those of ordinary skill in the art the above is a mere sampling of stack ranking variables, and that any other variables or combinations thereof are within the scope of embodiments described herein.

The syndication module 170 is communicatively coupled to the presence cache 165. The syndication module 170 dynamically displays respective ones of the plurality of agent profiles 140 across multiple webpages throughout the Web. The syndication module 170 may display the agent profiles 140 as advertisements across webpages on the Web, where the advertisements have dynamic content associated with different agents having varying metadata 145. Because the presence cache 165 includes real-time or near real-time updates to the plurality of metadata 145, including communication availability status, the syndication module 170 receives up-to-date metadata 145 information of the plurality of agent profiles 140.

The syndication module 170 may comprise a graphical user interface (GUI) to allow users or consumers to view agent profile advertisements across the Web, and allows agents to select websites to advertise their agent profile 140 on. The cache manager 115 pushes the plurality of agent profiles 140 to the presence cache 165 in real-time or near real-time such that the most updated agent profile data is continuously being received at the syndication module 170 and, in turn, throughout all webpages. Webpages may include landing pages, microsites, social media pages, search engine results, 3^{rd} party websites, or directories to name a few.

The following describes various illustrated embodiments of a method for establishing real-time P2P synchronous and asynchronous communication across a web portal. The various embodiments leverage real-time or near real-time updating of the metadata 145 associated with the agent profiles 140 to display and initiate real-time P2P synchronous and asynchronous communication options across the web portal. Embodiments described herein are directed to displaying the agent profiles 140 in the form of widgets, advertisements, or the like to web users in response to web searching or merely accessing a webpage.

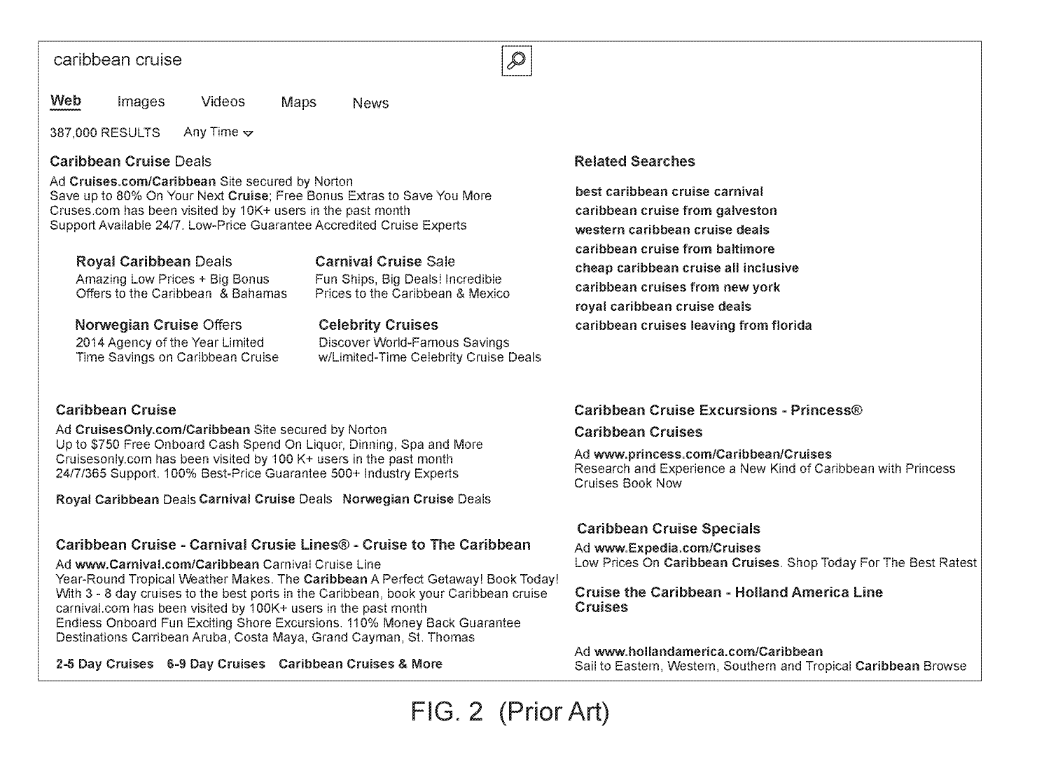

Reference is made to FIG. 2, which shows a graphical representation of a search engine results page (SERP) in response to the user entering a search for “Caribbean cruise.” The rendering of FIG. 2 illustrates the current state of the art when key words are entered into a search engine (e.g., GOOGLE, BING, BAIDU, ALEXA, SIRI, CORTANA).

Reference is made to FIG. 3, which shows the SERP displaying the plurality of agent profiles 140 proximate the search results. In particular, the search module 155 is communicatively coupled to the ad serving module 160 and the presence cache 165. The search module 155 may identify the respective ones of the plurality of agent profiles 140 to display above the fold (or above the scroll). As discussed above, the search module 155 may determine the plurality of agent profiles 140 to display based on the contextual relevance of the web search request. In the FIG. 3 example, because the context is “Caribbean cruise,” agents having experience as travel agents for Caribbean cruises are displayed by the system 100. Alternatively and/or additionally, the plurality of agents 140 displayed proximate the search results may be advertisements. For example, the rules engine of the cache manager 115 may set the plurality of rules to display the plurality of agents 140 based on advertising criteria or advertising relevance. In other words, the plurality of rules established by the rules engine may be set to allow respective ones of the agents to have their associated agent profiles 140 appear when specific web users enter web searches or access specific websites. In one example, one of the plurality of rules may establish that a first one of the agent profiles 140 be displayed when the user entering the search is from a specific location. Another one of the plurality of rules may establish that a second one of the agent profiles 140 be displayed when the user falls within a specified set of demographic and/or socio-economic criteria (e.g., age, sex, occupation, income bracket, education level, etc.).

It will be noted, regardless of whether the plurality of agent profiles 140 are identified and displayed in response to contextual relevance or advertisement relevance, the plurality of rules may determine whether to display only those agent profiles 140 having the communication availability status as AVAILABLE.

Reference is made to FIG. 4, which illustrates the SERP of FIG. 3 in response to the user selecting the communication socket 150 of the agent profile 140 of “Natalie Simpson.” In the illustrated embodiment, the real-time synchronous P2P chat session between the web user and the agent, “Natalie Simpson,” occurs in the communication web portal 400. The user may select the communication web portal 400 to appear on the SERP (as illustrated in FIG. 4) or may cause the communication web portal 400 to open as separate or new web page. Concurrently with the selection of the “Natalie Simpson” communication socket 150, the status server 120 may update the availability status of “Natalie Simpson.” In one example, the availability status may transition to UNAVAILABLE. In another example, the availability status of “Natalie Simpson” may remain AVAILABLE if the defined number of concurrent communication sessions allocated to “Natalie Simpson” has not been reached.

Reference is now made FIG. 5, which shows a graphical representation of a graphical user interface of the dashboard module 125, according to an illustrated embodiment. In this example, the user is “John Smith” and the agent is “Natalie Simpson.” As mentioned above, the dashboard module 125 may serve as the control interface to the plurality of agent profiles, in addition to governing the agent's real-time communication with the user. The dashboard module 125 may allow the respective managers of the plurality of agent profiles 140 (e.g., agents, organizations, and/or companies) to create or update at least some of the plurality of rules of the rules engine in the cache manager 115.

The graphical user interface of the dashboard module 125 includes extension panels 500 to provide helpful user-related information to the agent during the communication session. The extension panels 500 may include a co-browse panel which shows a visual representation of what the user (e.g., John Smith) is viewing online in real-time. The visual representation via the co-browse panel provides the agent with an understanding of the user's context prior to engaging in the P2P communication. In particular, the co-browser panel may share with the agent the publicly available metadata associated with the user by recreating that metadata on the graphical user interface of the dashboard module 125. For example, via the co-browse panel the agent may view the user's browser type (e.g., Safari, Firefox, Chrome), operating system, webpage address, and scrolling position to name a few.

The extension panels 500 may additionally include an area insights panel. The area insights panel may provide a visual rendering of the user's location and information associated about that market. It will be understood by those of ordinary skill in the art that additional or alternative extension panels may be included to maintain information about the user for the benefit of the agent.

Additionally, the dashboard module 125 GUI may provide an interface for the managers (e.g., agent or the agent's organization) to enter or purchase the advertising criteria for respective ones of the plurality of agent profiles 140. Furthermore, the dashboard module 125 GUI may provide an interface for the managers to set at least one of the plurality of rules, including defining the fairness doctrine. For example, the manager of the agent profile 140 may select via the dashboard module 125 GUI the markets to advertise in and the system 100 may automatically purchase the relevant key words or determine the relevant webpages the agent profile 140 should be displayed on.

FIG. 6A shows an illustration of an agent profile page accessed via an agent-specific URL (uniform resource locator) when the agent is available for synchronous communication, while FIG. 6B shows the agent profile page when the agent is available for asynchronous communication, according to one illustrated embodiment. As mentioned above, the unique URL (e.g., https://profile.engage.co/nataliesimpson) associated with the communication portal provides access to the agent's profile page 600. It is from the agent's profile page 600 that the user may initiate a synchronous or asynchronous communication with the agent. In one embodiment, the agent's profile page 600 allows for the dynamic switching between synchronous and asynchronous communication.

In particular, in response to the user linking to the agent profile page 600, the agent profile module 135 may determine that agent's availability via the real-time or near real-time communication with the cache manager 115. The agent's availability may be automatically set based on the number of concurrent communication sessions of the agent or manually set to UNAVAILABLE by the agent. For example, the status server 120 may be set to limit the agent's concurrent number of communication sessions to a defined number, after which the agent's availability status is set to UNAVAILABLE. The agent automatically becomes AVAILABLE once the concurrent number of communication sessions drops below the defined amount.

FIG. 6A illustrates an example where the profile module 135 determined the agent as AVAILABLE for synchronous communication. As such, the user may select the communication socket 150 (e.g., “Engage Live” icon) to initiate the synchronous P2P communication. On the other hand, FIG. 6B an example where the profile module 135 determined the agent is unavailable for synchronous communication, but provides the option of asynchronous communication. Asynchronous communication may take the form of an email message, text message, mobile push notification, or desktop push notification the system 100 forwards to the agent for retrieval sometime in the future (e.g., when the agent checks his/her email account, mobile device, or desktop computer).

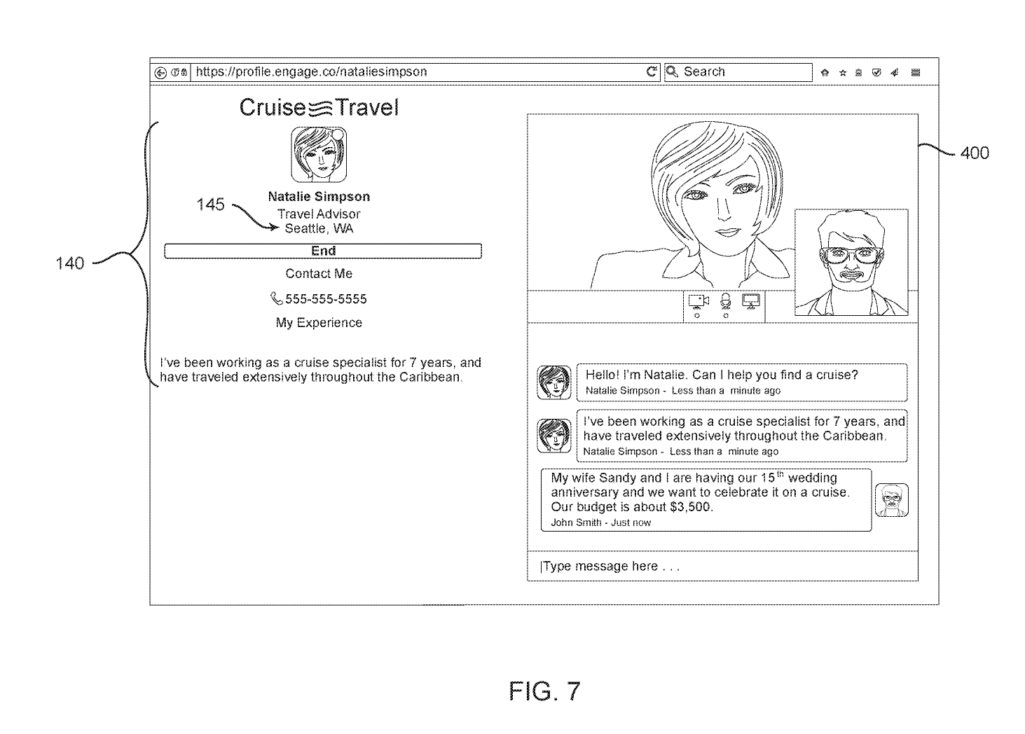

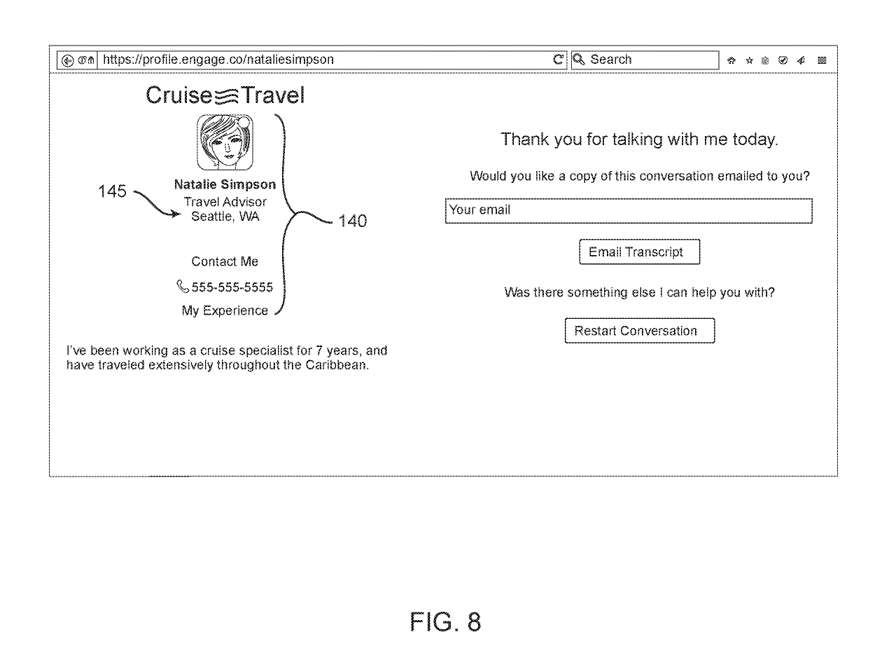

FIG. 7 shows an illustration of the user having a synchronous P2P chat communication with the agent via the unique URL, while FIG. 8 shows the agent profile page upon conclusion of the communication session, according to one illustrated embodiment. As mentioned above, the web portal 400 may be opened as part of the SERP itself (FIG. 4), or may be open in its own webpage, as illustrated in FIG. 7. The user may initiate the communication session via selecting the communication socket 150 directly on the agent profile 140 displayed on the SERP or by entering the unique URL into a web browser. Upon conclusion of the chat communication session, the user may request a transcript of the communication via email. Of course, at any time, the user may attempt to re-establish communication with the same agent via the unique link. If the agent is AVAILABLE, then there is implied acceptance by the agent to initiate a synchronous P2P communication. On the other hand, if the agent is UNAVAILABLE, then the asynchronous communication option is available to the user, as illustrated and described in FIG. 6B.

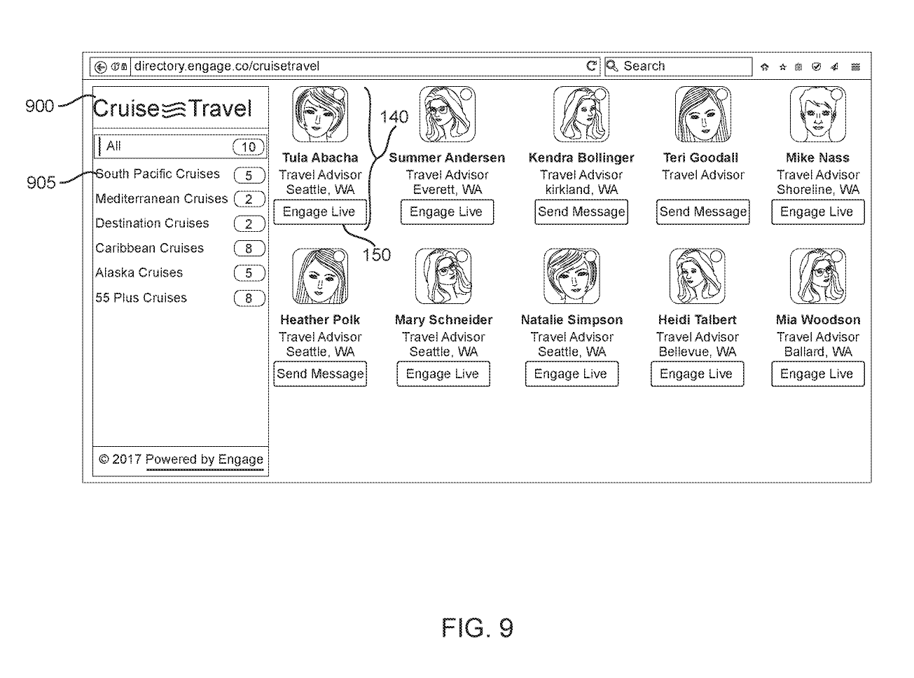

FIG. 9 shows an illustration of an organization or company directory, including the plurality of agent profiles 140 associated with the organization, according to one illustrated embodiment. The search module 155 may, for example, index intranet pages within the organization having the plurality of agent profile 140 associated therewith. For example, the agents associated with the plurality of agent profiles may be employees of the organization or company (e.g., travel agents as employees of a travel company or sales agents as employees of a retailer). In response to the user inputting a search within the organization directory, the search module 165 may search the indexed intranet pages of the organization. In such embodiment, as illustrated in FIG. 9, the search module 155 may generate a results page or directory comprising a listing of respective ones of the plurality of agent profiles 140 relevant to the user search request. The resulting listing of agent profiles 140 may have metadata 145 contextually relevant to the search request. The contextual relevance determination may be similar to that described above with regard to the web search request via a search engine. Additionally and/or alternatively, the directory of agent profiles 140 may be filtered via defined metadata 905 set by the organization 900.

Having described some embodiments of the invention, additional embodiments will become apparent to those skilled in the art to which it pertains. Specifically, although reference was made throughout the specification and drawings to users running a keyword web search query on a search engine, it will be appreciated that the system 100 and method embodiments are also relevant to the user accessing various websites and having relevant ones of the plurality of agent profiles displayed as advertisements on various websites throughout the Web. The embodiment of the search engine results page (SERP), was not intended to limit the system 100 in any way but a mere example of leveraging the metadata of the agent profiles as object data to provide options for synchronous P2P communication with agents relevant to the web users. For example, the display of relevant plurality of agent profiles may occur when the web user accesses a website. The system 100 may determine respective ones of the plurality of agent profiles to display as advertisements on the webpages based on contextual relevance or advertising criteria. Similarly to the SERP embodiments, the contextual relevance may be determined by analyzing content and/or metadata of a webpage to be accessed against the metadata associated with the plurality of available agent profiles. Furthermore, the advertising criteria may be purchased by the agents and/or the organizations such that specified ones of the plurality of agent profiles will be displayed on the webpage even if not contextually relevant.

Embodiments of the system and method include automatically updating the metadata associated with the plurality of agent profiles regardless of the display location of the agent profiles.

Additionally, embodiments of the system and method include voice-implemented web searching. For example, the web user may implement the web search via a search engine provider or directly access a webpage by way of voice commands. Embodiments disclosed herein are not limited to text search but includes any other mode of searching for content on the Web.

While the particular methods, devices and systems described herein and described in detail are fully capable of attaining the above-described objects and advantages of the invention, it is to be understood that these are example embodiments of the invention and are thus representative of the subject matter which is broadly contemplated by the present invention, that the scope of the present invention fully encompasses other embodiments which may become Obvious to those skilled in the art, and that the scope of the present invention is accordingly to be limited by nothing other than the appended claims, in which reference to an element in the singular means “one or more” and not “one and only one”, unless otherwise so recited in the claim,

It will be appreciated that modifications and variations of the invention are covered by the above teachings and within the purview of the appended claims without departing from the spirit and intended scope of the invention.

What is claimed is:

1. A system for establishing peer-to-peer communication options based on web search relevance, the system comprising:
a presence cache configured to store a plurality of agent profiles, wherein each of the plurality of agent profiles includes a communication socket and one or more metadata;
a rules engine configured to apply a plurality of rules to the one or more metadata associated with the plurality of agent profiles, the plurality of rules along with the metadata are pushed to the presence cache; and
a search module communicatively coupled to the presence cache and operable to receive at least one web search request from a user and retrieve available ones of the at least one of the plurality of agent profiles relevant to the at least one web search request based on the plurality of rules from the rules engine.

2. The system of claim 1, wherein each of the plurality of agent profiles comprises structured data including at least one of rich interactive advertisement, rich media, text-based data object, or a widget.

3. The system of claim 1, wherein the available ones of the at least one of the plurality of agent profiles are available to establish a synchronous communication with the user.

4. The system of claim 3, wherein the synchronous communication comprises at least one of voice over internet protocol, video over internet protocol, or text-based communication.

5. The system of claim 4, wherein the synchronous communication is established in response to the user selecting the communication socket from the at least one of the retrieved plurality of agent profiles to open a communication portal with an owner of the at least one of the retrieved plurality of agent profiles.

6. The system of claim 5, wherein the communication portal has a unique URL associated therewith for future retrieval by the user.

7. The system of claim 1, wherein the available ones of the at least one of the plurality of agent profiles are retrieved in response to content of a search engine results page being contextually relevant to the one or more metadata of respective ones of the retrieved plurality of agent profiles.

8. The system of claim 1, wherein the available ones of the at least one of the plurality of agent profiles are retrieved in response to keywords used to implement the at least one web search request matching the one or more metadata of the retrieved at least one of the plurality of agent profiles.

9. The system of claim 1, wherein the retrieved available ones of the at least one of the plurality of agent profiles are retrieved in response to a geolocation of the user matching the one or more metadata of the retrieved at least one of the plurality of agent profiles.

10. The system of claim 1, wherein the search module is further configured to stack rank the retrieved at least one of the plurality of agent profiles based on the plurality of rules.

11. The system of claim 1, wherein the search module displays the retrieved at least one of the plurality of agent profiles on a search engine results page proximate search engine results.

12. The system of claim 1, wherein the search module displays the retrieved at least one of the plurality of agent profiles as an advertisement on a webpage.

13. The system of claim 1, wherein the plurality of rules are created by respective managers of the plurality of agent profiles.

14. The system of claim 13, wherein the managers include at least one of individuals represented by the plurality of agent profiles or organizations the individuals are affiliated with.

15. The system of claim 14, wherein the respective one or more metadata associated with the plurality of agent profiles comprises at least one of availability status of the communication socket, purchased keywords, geographic location, skills, job title, subject matter expertise, organization affiliation, or cost-per-dialogue rate.

16. The system of claim 15, wherein the availability status of the communication socket associated with the plurality of agent profiles is updated in real-time by the respective managers of the plurality of agent profiles.

17. The system of claim 16, further comprising a status server configured to update the availability status of the communication socket in real-time.

18. The system of claim 17, herein the status server configured to update the availability status includes updating the availability status to unavailable for respective ones of the plurality of agent profiles in response to the respective ones of the plurality of agent profiles conducting a defined number of concurrent communications.

19. A non-transitory computer readable medium having a memory and instructions stored therein that when executed by a processor performs a method for establishing peer-to-peer communication options based on web search relevance, the method comprising:
storing a plurality of agent profiles wherein each of the plurality of agent profiles includes a communication socket and one or more metadata;
applying a plurality of rules to the one or more metadata associated with the plurality of agent profiles; and
in response to input of at least one web search request from a user, retrieving available ones of the at least one of the plurality of agent profiles relevant to the at least one web search request based on the plurality of rules.

20. The non-transitory computer readable medium of claim 19, wherein storing the plurality of agent profiles includes storing structured data, the structured data comprises at least one of rich interactive advertisement, rich media, text-based data object, or a widget.

21. The non-transitory computer readable medium of claim 19, wherein retrieving available ones of the at least one of the plurality of agent profiles further includes establishing a synchronous communication with the user.

22. The non-transitory computer readable medium of claim 19, wherein establishing the synchronous communication includes establishing at least one of voice over internet protocol, video over internet protocol, or text-based communication.

23. The non-transitory computer readable medium of claim 22, wherein establishing the synchronous communication includes opening a communication portal in response to the user selecting the communication socket from the at least one of the retrieved plurality of agent profiles.

24. The non-transitory computer readable medium of claim 23, wherein opening the communication portal includes associating a unique Uniform Resource Locator (URL) with the communication portal for future access by the user.

25. The non-transitory computer readable medium of claim 19, wherein retrieving available ones of the at least one of the plurality of agent profiles includes determining content of a search engine results page is contextually relevant to the one or more metadata of respective ones of the retrieved plurality of agent profiles.

26. The non-transitory computer readable medium of claim 19, wherein retrieving available ones of the at least one of the plurality of agent profiles includes matching keywords used to implement the at least one web search request with the one or more metadata of respective ones of the retrieved plurality of agent profiles.

27. The non-transitory computer readable medium of claim 19, wherein retrieving available ones of the at least one of the plurality of agent profiles includes matching an IP geolocation of the user with the one or more metadata of respective ones of the retrieved plurality of agent profiles.

28. The non-transitory computer readable medium of claim 19, further comprising stack ranking the retrieved at least one of the plurality of agent profiles based on the plurality of rules.

29. The non-transitory computer readable medium of claim 19, further comprising displaying the retrieved at least one of the plurality of agent profiles on a search engine results page proximate search engine results.

30. The non-transitory computer readable medium of claim 19, further comprising displaying the retrieved at least one of the plurality of agent profiles as an advertisement on a webpage.

31. The non-transitory computer readable medium of claim 19, wherein_applying a plurality of rules includes creating the plurality of rules by respective managers of the plurality of agent profiles.

32. The non-transitory computer readable medium of claim 31, wherein_creating the plurality of rules by respective managers of the plurality of agent profiles includes creating the plurality of rules by at least one of individuals represented by the plurality of agent profiles or organizations the individuals are affiliated with.

33. The non-transitory computer readable medium of claim 32, wherein applying a plurality of rules to the one or more metadata includes applying the plurality of rules to at least one of availability status of the communication socket, purchased keywords, geographic location, profile image, skills, job title, subject matter expertise, organization affiliation, or cost-per-dialogue rate.

34. The non-transitory computer readable medium of claim 33, further comprising real-time updating the availability status of the communication socket by the respective managers of the plurality of agent profiles.

35. The non-transitory computer readable medium of claim 34, wherein the real-time updating includes updating the availability status to unavailable for respective ones of the plurality of agent profiles in response to the respective ones of the plurality of agent profiles conducting a defined number of concurrent communications.

36. A non-transitory computer readable medium having a memory and instructions stored therein that when executed by a processor performs a method for establishing peer-to-peer communication options syndicated to locations throughout a World Wide Web, the method comprising:
storing a plurality of agent profiles, wherein each of the plurality of agent profiles includes a communication socket and one or more metadata;
associating one or more webpages with each of the plurality of agent profiles, wherein metadata of each of the plurality of agent profiles is updated in real-time; and
retrieving at least one of the plurality of agent profiles to be served to at least one webpage of the one or more webpages in response to the at least one webpage being accessed by a user.

37. The non-transitory computer readable medium of claim 36, wherein the plurality of agent profiles take the form of structured data, the structured data comprises at least one of rich interactive advertisement, rich media, text-based data object, or a widget.

38. The non-transitory computer readable medium of claim 36, wherein retrieving available ones of the at least one of the plurality of agent profiles further includes establishing a synchronous communication with the user.

39. The non-transitory computer readable medium of claim 38, wherein establishing the synchronous communication includes establishing at least one of voice over internet protocol, video over internet protocol, or text-based communication.

40. The non-transitory computer readable medium of claim 39, wherein establishing the synchronous communication includes opening a communication portal in response to the user selecting the communication socket from the at least one of the retrieved plurality of agent profiles.

41. The non-transitory computer readable medium of claim 40, wherein opening the communication portal includes associating a unique Uniform Resource Locator (URL) with the communication portal for future access by the user.

42. The non-transitory computer readable medium of claim 36, wherein updating the metadata of each of the plurality of agent profiles includes real-time updating of at least one of availability status of the communication socket, profile image, skills, job title, subject matter expertise, organization affiliation, or cost-per-dialogue rate.

43. The non-transitory computer readable medium of claim 42, wherein the real-time updating includes updating the availability status to unavailable for respective ones of the plurality of agent profiles in response to the respective ones of the plurality of agent profiles conducting a defined number of concurrent communications.
